(19) United States
(12) Patent Application Publication
(10) Pub. No.: US 2025/0272980 A1
(43) Pub. Date: Aug. 28, 2025

(54) SPATIAL COMPUTING DEVICE FOR USE WITH TELEMETRY-BASED USER BEHAVIOR ANALYSIS FOR LEVERAGING SUGGESTIVE ACTION MECHANISMS

(71) Applicant: Bank of America Corporation, Charlotte, NC (US)

(72) Inventors: Shailendra Singh, Maharashtra (IN); Saurabh Gupta, New Delhi (IN)

(21) Appl. No.: 18/585,183

(22) Filed: Feb. 23, 2024

(51) Int. Cl. G06V 20/52; G06V 40/20; H04N 13/282

(52) U.S. Cl. CPC G06V 20/52; G06V 40/20; H04N 13/282

(57) ABSTRACT

A method for utilizing a spatial computing device with telemetry-based user-behavior analysis for leveraging suggestive action mechanisms options. The method may include retrieving, using the spatial computing device, a 360° view of a transaction area. Based on the 360° view of the transaction area, the method may include forming a pre-transaction suggestion with respect to the transaction area, based also on a pre-transaction integration, as well as other analysis performed at a central server. The method may include transmitting an enabling prompt to the spatial computing device. The enabling prompt may be configured to receive a transaction execution command.

### FIELD OF TECHNOLOGY

Aspects of the disclosure relate to spatial computing devices.

### BACKGROUND OF THE DISCLOSURE

The Internet of Behavior (“IoB”) brings together the fields of data analysis, behavioral analysis, and technology along with human psychology. Various disciplines have not yet fully leveraged advantages potentially available via the IoB.

For example, much effort has been directed to analyzing client performance data from various channels to predict future payments. Yet, client behavior, which can convey a wealth of potentially industry transformative information, has yet to be mined.

It would be desirable to provide a technology that integrates all of a customer's spatial computing devices, interprets client behavior and pre-integrates and pre-wires information relevant to client actions.

It would be desirable to use such systems to raise the client experience to another level and substantially simultaneously reduce fraudulent behavior.

### SUMMARY OF THE DISCLOSURE

Spatial computer apparatus and systems are entering common use. Such systems may map a user's 3D surroundings. Such systems may also project virtual objects, which may be associated with a hyperlink, onto a visual field of a user and may anchor a virtual object to a physical object. Examples of suitable spatial computer apparatus may include smartglasses, augmented reality (“AR”) devices, extended reality (“XR”) devices or other suitable devices.

Systems and methods provided according to the disclosure create spatial computing devices for use with telemetry-based user behavior analysis for implementing a suggestive action mechanism. Such systems and methods preferably integrate a client's spatial computing devices into a single platform. Further, such systems and methods interpret a client's environment and behavior.

The systems and methods leverage the interpretation of the client's environment and behavior to preferably pre-integrate with all the receivers/senders to enable a seamless transaction system. Furthermore, such pre-integration can regulate suggestive action mechanisms—i.e., a system that provides dynamic suggestions as well as actionable mechanisms for acting on such advice—such as an offer/payment system or other relevant suggestive action systems.

Technology according to the disclosure enables an entity to gather client's behavioral data from their spatial computing devices, or from some other mobile device such as a cellphone. The technology can then analyze the behavioral data using an iterative adjunction technique to deduce environment and behavior.

For the purposes of this application, an iterative adjunction technique preferably analyzes each set of environmental and/or behavioral data as a root node. The root node can be used to create a graph or a portion of a graph.

For each iteration of the graph and data analysis of the user environmental and/or behavioral data, the system iterates through every attribute of the data collected and calculates the information gain of that attribute. Following the collection and calculation of the information gain of the specific attribute, the system may then add to an attribute-relevant branch of the graph.

Each information gain contributes to the graph by adding a new node to the graph. Such a graph may continue to grow until all the received data is analyzed. Root nodes of the graph determine the environmental/behavioral decisions that technology according to the current disclosure leverages in order to suggest a course of action to a customer and for prior device integration. Such prior device integration may include prior transaction device integration—i.e., establishing a particular device as eligible to perform transactions on behalf of a user.

Technology according to the disclosure may enable gathering and analyzing data reflective of a customer's environment through data telemetry received from a spatial computing device. Preferably, the system invokes and analyzes 360° viewing systems and suggests recommendations based on such environmental information. The system preferably involves artificial intelligence (“AI”) system(s) to monitor and integrate data sources of critical behavior, environmental status, geo-location, demographics, language information or other suitable information sources. Following receipt and analysis of information, and based on such receipt and analysis, from the aforementioned information sources, the system may then provide transaction suggestions.

Embodiments according to the disclosure may enable an entity to gather and analyze customer's behavior from past transactions—like which transactions made customers happy versus sad (for example, by analyzing online reviews posted by the same or other customers) at some pre-determined, post-transaction, amount of time; during which days of the month a client transacts at a higher amount per unit time; when did customer request a return of product; to which store area a customer typically approaches first (a metric potentially derived from a count of steps walked in a biometric recording device such as a watch or other suitable device); etc. The entity may suggest various options to a client based upon the foregoing and can pre-integrate one or more client devices, such as a mobile smart phone device, or exercise/biometric device, or other suitable device, with respective vendors.

For example, some embodiments set forth herein enable an entity to integrate with a client's mobile communication device, such a smart phone, and to interpret the client's behavior with respect to transaction location, transacted products, transaction pattern, and/or transaction frequency. For example, if an entity client travels to a Florida Superstore every 10 days to purchase a specific children's food product, then the embodiments set forth herein may interpret that behavior and message the customer—“Hi John! Hope you are here to buy ABC Cerelac for your child. With your permission, can we make a pre-transaction payment of $121 to the Florida Superstore right now?” Upon receiving confirmation from the customer, the system may pre-wire the Florida Superstore payment system with the customer's payment digital wallet. Additionally, the Florida Superstore may be alerted to trace the product and prepare it, so as to be ready for customer pick-up.

A system for telemetry-based user-behavior analysis is provided. The system may include leveraging suggestive action for mechanisms. The system may include a spatial computing device for retrieving and monitoring a 360° view of a transaction area.

The spatial computing device may be further operable to perform environmental analysis of the transaction area. Such environmental analysis may include temperature analysis, humidity analysis, lighting analysis and/or any other suitable environmental factor analysis. For example, if the lighting is subdued in the transaction area, this may, in combination with humidity analysis, signal that the outdoor skies are currently overcast and purchase of an umbrella may be suggested.

The spatial computing device may invoke customer physical behavior analysis in the transaction area. Such customer physical behavior analysis may include analysis of the physical movements, a body temperature of the user or any other suitable metric associated with the user. The physical movements of the user may indicate that the user requires a walking aid such as a cane or a walker. Thus, the physical movements of the user may cause the system to suggest to the user to purchase a cane, to the extent that such a cane is within the transaction area.

The spatial computing device may invoke review of user sentiment of legacy transactions in the transaction area. Such review may reveal that the user sentiment is generally positive vis-à-vis transactions made in the transaction area. As such, the system may suggest that the user tend toward purchasing in the transaction area, as opposing to suggesting that the user resist purchasing in the transaction area.

The spatial computing device may monitor a user transaction trend in the transaction area. Such review may reveal that the user purchasing trend is generally increasing vis-à-vis transactions made in the transaction area. As such, the system may suggest that the user tend toward purchasing in the transaction area, as opposing to suggesting that the user resist purchasing in the transaction area.

The spatial computing device may monitor a user transaction product pattern in the transaction area. Such review may reveal that the user has made transactions on alternating days in the transaction area. As such, the system may suggest that the user tend toward purchasing in the transaction area only when it is within the users transaction pattern, and suggesting that the user resist purchasing on the days when the user typically does not transact in the transaction area. It should be noted that such suggestions should be tempered by the logic behind the pattern, to the extent that such a logic exists.

Some embodiments may identify a geo-location of the transaction area. Such a geo-location may indicate that the transaction is in a different geo-location than a similar transaction area in a different geo-location. For example, two identical department stores being in different locations may cause the system to offer different suggestions. For example, when a user is close to his or her home, the system may suggest that the user purchases a relatively larger amount of goods, as transport of the goods to the user's home will be easier and quicker, whereas if the geo-location of the transaction is more distant from the user's home the system may suggest to resist purchasing a larger amount of goods to reduce transport costs.

The system may form a pre-transaction integration of the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area. Once formed, a central server may, based on receipt and review of the pre-transaction integration, instruct the spatial computing device to transmit to the central server the pre-transaction integration which, in turn and following possible internal review in conjunction with an AI database, transmit an enabling prompt to the spatial computing device. The enabling prompt may be configured to receive a transaction execution command.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows a schematic diagram of a spatial computing device in use by a spatial computing device user;

FIG. 4 shows an exemplary hybrid system/flow diagram of a method in accordance with the principles of the disclosure;

FIG. 5 shows an illustrative flow diagram of an implementation of an iterative adjunctive technique according to the disclosure;

FIG. 6 shows another illustrative flow diagram of an implementation of an iterative adjunctive technique in accordance with principles of the disclosure; and

FIG. 7 shows a schematic diagram of a spatial suggestive transaction system in accordance with principles of the disclosure.

### DETAILED DESCRIPTION OF THE DISCLOSURE

Systems and methods are provided for utilizing a spatial computing device with telemetry-based user-behavior analysis for leveraging suggestive action mechanisms, is provided. The method may include retrieving, using the spatial computing device, a 360° view of a transaction area.

The method may also include performing environmental analysis of the transaction area and invoking customer physical behavior analysis in the transaction area. In addition, the method may include reviewing user sentiment of legacy transactions in the transaction area. Also, the method may include monitoring a user transaction trend in the transaction area. Further, the method may include monitoring a user transaction product pattern in the transaction area and identifying a geo-location of the transaction area.

Based on the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area, the method may additionally include forming a pre-transaction integration of the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area.

Based on the pre-transaction integration, the method may include transmitting an enabling prompt to the spatial computing device. The enabling prompt may be configured to receive a transaction execution command.

The method using the spatial computing device and retrieving the 360° view of the transaction area, may assign one or more anchors to sub-regions within the transaction area, assign one or more anchors to each of a plurality of individual products within the transaction area, or assign one or more spatial anchors to each of a plurality of groups of products within the transaction area.

The system may further implement the telemetry-based user-behavior analysis using an iterative adjunction technique. The iterative adjunction technique to analyze each of the 360° view of the transaction area. In order to provide a root node in a graph, the method may utilize the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area.

The iterative adjunction technique may further iterate through one or more information gains. Each of the information gains are used to generate an additional node on the graph.

Each additional node(s) on the graph may be leveraged to provide the pre-transaction integration for a formation of the enabling prompt.

The iterative adjunction technique may also iterate through one or more information gains. Each of the one or more information gains may be associated with an information delta derived from a change to any one of the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

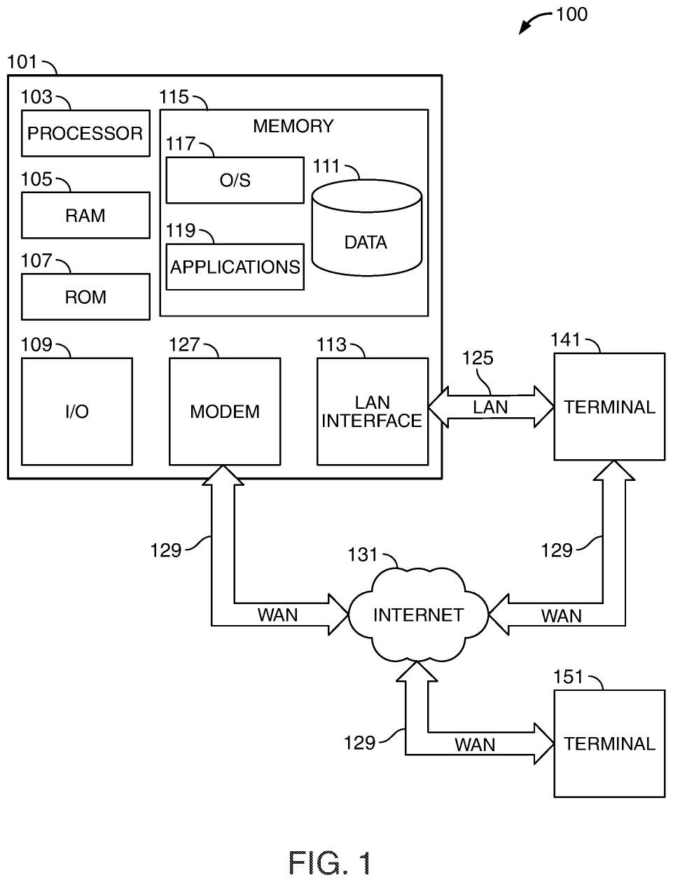

FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and memory 115. Microprocessor(s) 103 may also execute all software running on the computer 101—e.g., operating system 117 and applications 119 such as an AI-implemented termination program and security protocols. Other components commonly used for computers, such as EEPROM or Flash memory or any other suitable components, may also be part of computer 101.

Memory 115 may include any suitable permanent storage technology—e.g., a hard drive or other non-transitory memory. ROM 107 and RAM 105 may be included as all or part of memory 115. Memory 115 may store software including the operating system 117 and application(s) 119 (such as the AI-implemented termination program and security protocols) along with any other data 111 (e.g., historical data, configuration files) needed for the operation of apparatus 100. Memory 115 may also store applications and data. Alternatively, some or all of computer executable instructions (alternatively referred to as “code”) may be embodied in hardware or firmware (not shown). Microprocessor 103 may execute the instructions embodied by the software and code to perform various functions.

A network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, Wi-Fi, cellular networks, or other suitable frequencies.

Any memory may be comprised of any suitable permanent storage technology—e.g., a hard drive or other non-transitory memory. The memory may store software including an operating system and any application(s) (such as an artificial intelligence implemented termination program and security protocols) along with any data needed for the operation of the apparatus and to allow bot monitoring and IoB device notification. The data may also be stored in cache memory, or any other suitable memory.

Input/output (“I/O”) module 109 may include connectivity to a button and a display. Input/output module 109 may also include one or more speakers for providing audio output and a video display device, such as an LED screen and/or touchscreen, for providing textual, audio, audiovisual, and/or graphical output.

In an embodiment of computer 101, microprocessor 103 may execute the instructions in all or some of the operating system 117, any applications 119 in the memory 115, any other code necessary to perform the functions described in this disclosure, and any other code embodied in hardware or firmware (not shown).

In an embodiment, apparatus 100 may consist of multiple computers 101, along with other devices. Computer 101 may be a mobile computing device such as a smartphone or tablet.

Apparatus 100 may be connected to other systems, computers, servers, devices, and/or Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. References to the “cloud-based applications” generally refer to applications located on a server remote from a user, wherein some or all of the application data, logic and instructions are located on the internet and are not located on a user's local device. Cloud-based applications may be accessed via any type of internet connection (e.g., cellular or Wi-Fi).

Terminals 141 and 151 may include personal computers, smart mobile devices, smartphones, IoT devices, or servers that include many or all of the elements described above relative to apparatus 100. The network connections depicted in FIG. 1 include local area network (LAN) 125 and wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through LAN interface or adapter 113. When used in a WAN networking environment, computer 101 may include modem 127 or other means for establishing communications over WAN 129, such as Internet 131. Modem 127 and/or LAN interface 113 may connect to a network via an antenna (not shown). The antenna may be configured to operate over Bluetooth, Wi-Fi, cellular networks or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Applications 119 (which may be alternatively referred to herein as “plugins,” “application programs” or “apps”) may include computer executable instructions for an AI-implemented termination program and security protocols, as well as other programs. In an embodiment, one or more programs, or aspects of a program, may use one or more artificial intelligence/machine learning (“AI/ML”) algorithm(s). The various tasks may be related to terminating or preventing a malicious AI from completing its malicious activities.

Computer 101 may also include various other components, such as a battery (not shown), speaker (not shown), a network interface controller (not shown), and/or antennas (not shown).

Terminal 151 and/or terminal 141 may include portable devices such as a laptop, cell phone, tablet, smartphone, server, or any other suitable device for receiving, storing, transmitting and/or displaying relevant information. Terminal 151 and/or terminal 141 may include other devices such as remote computers or servers. The terminals 151 and/or 141 may be computers through/at which a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media, including memory storage devices.

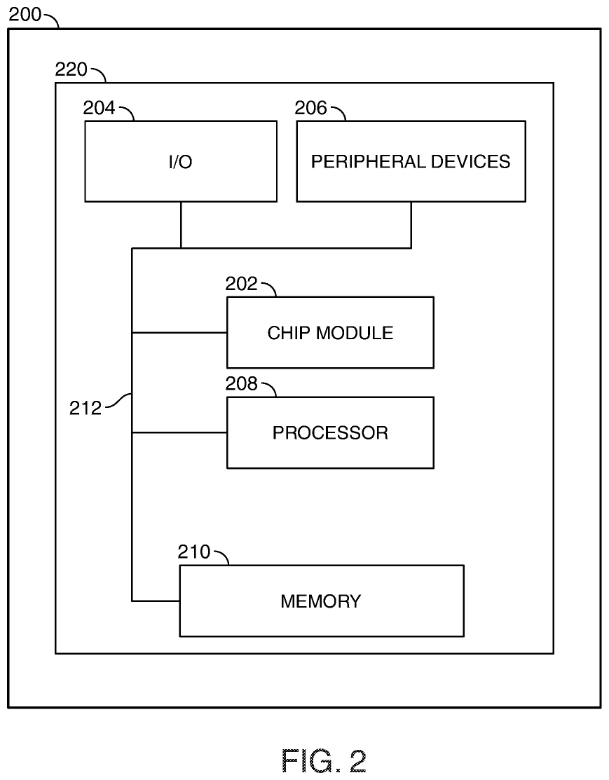

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1 and 3-7. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface via fiber optic cable, coaxial cable, telephone lines, wireless devices, PHY layer hardware with a keypad/display control device; a display (LCD, LED, OLED, etc.); a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

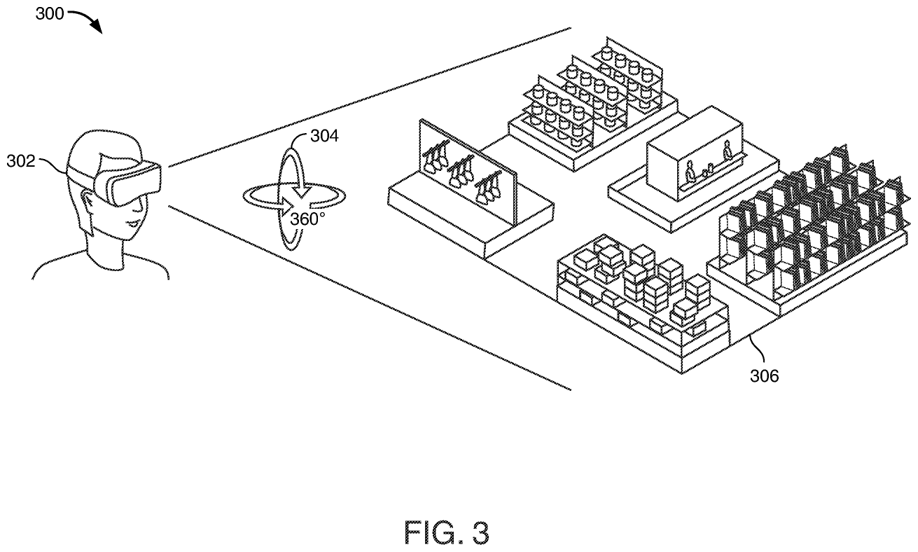

FIG. 3 shows a schematic diagram 300 of spatial computing device 302 in use by a spatial computing device user. A 360° indicator is shown at 304 to indicate the full 360° extent of viewing available to the user through device 302.

At 306, an exemplary shopping region is shown. Region 306 indicates an entire region of a brick-and-mortar retail entity to a shopper wearing spatial computing device 302.

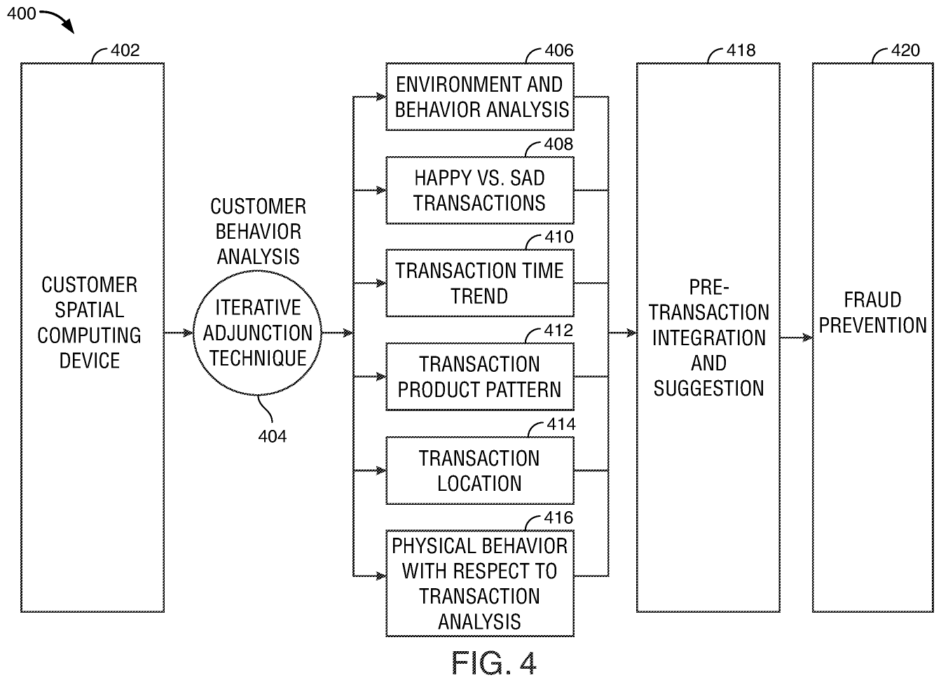

Information derived from region 306 may be utilized in combination with a customer Internet of Behavior (“IoB”) connection as set forth herein and integrated with spatial computing telemetry to generate suggestions and suggestive payments and offers. Some embodiments of methods and systems use spatial computing maps together with environment and behavior analysis, as well as the other information inputs set forth in FIG. 4 (below) to make suggestions and to suggest payment and offers on real time.

FIG. 4 shows an exemplary hybrid system/flow diagram of a method in accordance with the principles of the disclosure. At 402, a customer spatial computing device is indicated.

Customer behavior analysis may be performed. In one embodiment of the disclosure, an iterative adjunction technique may be implemented for customer behavior analysis, as shown at 404.

Such an iterative adjunction technique may involve analyzing each set of environmental and/or behavioral data, and/or other input data, using discrete informational gain elements of the environmental and/or behavioral data to form one or more than one individual root node in a graph for suggesting and/or implementing user decision making.

One or more of such root nodes may then be leveraged to initiate creation of a graph or a portion of a graph. The graph may continue to be built and elaborated upon. The continuing building may be implemented upon continuing receipt and analysis of environmental and/or behavioral data in the form of information gains. It should be noted that environmental analysis and behavioral analysis may be performed using one or more suitable techniques other than an iterative adjunction technique.

As described above, the behavioral analysis instantiated as iterative adjunction technique 404 may include information derived from such exemplary information as environmental and behavioral analysis 406, stored information relating to happy versus sad transactions 408, transaction trend time information 410, transaction product pattern information 412, transaction location 414 and physical behavior with respect to transaction analysis 416.

Information 406, 408, 410, 412, 414 and 416 may preferably be integrated at a pre-transaction juncture of a transaction or other suitable transaction time—e.g., during the transaction—and a suggestion may be offered based on the integration, as shown at 418.

Further implementations of such embodiments may preferably include using the input information for fraud detection, as shown at 420. In one scenario, the various input information can be compared to legacy information to determine whether such input information represents an information gain vis-à-vis the current information.

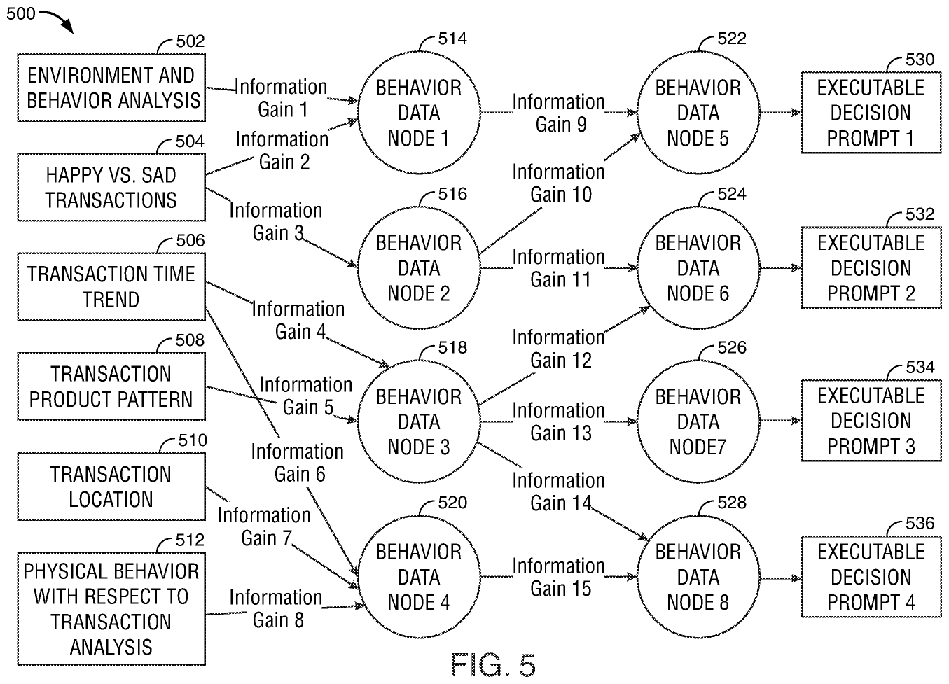

FIG. 5 shows an illustrative flow diagram of an implementation of an iterative adjunctive technique 500 according to the disclosure.

Technology according to the embodiments preferably enable an entity to gather and analyze various input data including, but not limited to, environmental and behavioral analysis 502, stored information relating to happy versus sad transactions 504, transaction trend time information 506, transaction product pattern information 508, transaction location 510 and/or physical behavior with respect to transaction analysis 512, each of which may include data on the customer's environment through data telemetry received from a spatial computing device. Such technology can preferably analyze a 360° physical view and suggest an executable recommendation.

Further, the technology preferably includes a built-in AI system. The AI system may be invoked to observe a 360° physical view and derive, therefrom, information regarding critical behavior, environment, geo-location, demographics, language and/or other suitable inputs. Thereafter, the AI system may suggest, based on the input information, executable suggestions such as transaction execution suggestions, offers and payment or other suitable suggestions.

Furthermore, each discreet information gain in the information input, such as information gains 1-8 and 9-15 shown in FIG. 5, can be used, according to iterative adjunction. Specifically, one or more of the information gains can be used to generate one or more than one behavioral data node, such as behavioral data node 514, behavioral data node 516, behavioral data node 518, behavioral data node 520, behavioral data node 522, behavioral data node 524, behavioral data node 526, behavioral data node 528, etc. As shown in FIG. 5, one or more behavioral nodes 514-528 may form a multi-level AI system.

It should be noted further that information gains 1-8 may preferably represent a first set of information gains while, in some embodiments, information gains 9-15 may represent a second set of information gains. The first set of information gains may differ from the second set of information gains at least because the first set of information gains are derived directly from information inputs while the second set of information are derived from generated behavior data nodes. Such a second set of information, derived from generated behavior data nodes, may be considered a second level of information vis-à-vis the input information.

In certain embodiments, the information gains derived from the generated behavior data nodes may include weighting factors associated with the generated behavior data nodes. The weighting factors may further refine the information received by the generated behavior data nodes to produce second level information gains. The second level information gains may then be transferred to a second set (or, iteratively, an Nth set) of behavior data nodes, prior to triggering an executable decision prompt.

Each node in the final level of the depth of behavioral nodes 514-528 may be coupled to a discreet executable decision prompt, such as executable decision prompt 1 at 530, executable decision prompt 2 at 532, executable decision prompt 3 at 534, and executable decision prompt 4 at 536. Such prompts may be transmitted to a user-actionable screen for action.

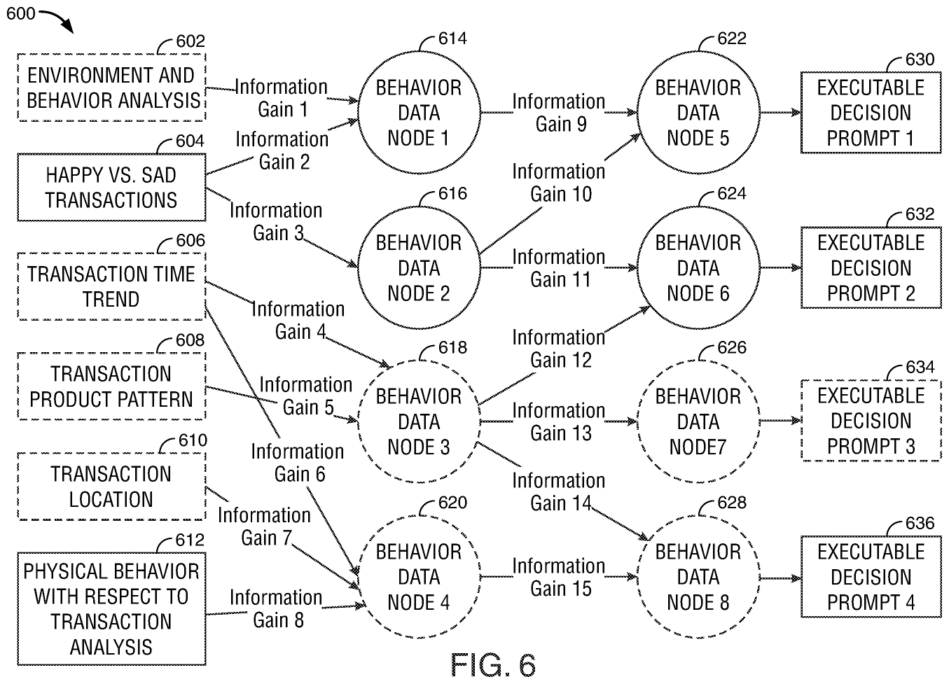

FIG. 6 shows another illustrative flow diagram of an implementation of an iterative adjunctive technique 600 according to the disclosure. For example, FIG. 6 shows, similar to FIG. 5, information input nodes for receiving information related to environmental and behavioral analysis 602, stored information relating to happy versus sad transactions 604, transaction trend time information 606, transaction product pattern information 608, transaction location 610 and/or physical behavior with respect to transaction analysis 612.

FIG. 6 also shows information gains 1-15, which can be used, according to iterative adjunction, to form a behavioral data node, such as behavioral data node 614, behavioral data node 616, behavioral data node 618, behavioral data node 620, behavioral data node 622, behavioral data node 624, behavioral data node 626, behavioral data node 628, etc. As shown in FIG. 6, behavioral nodes 614-628 may form a multi-level AI system.

Similar to FIG. 5, each node in the final level of the depth of behavioral nodes 614-628 may be coupled to a discreet executable decision prompt, such as executable decision prompt 1 at 630, executable decision prompt 2 at 632, executable decision prompt 3 at 634, and executable decision prompt 4 at 636. Such prompts may be transmitted to a user-actionable screen for action.

FIG. 6 also indicates that inputs environmental and behavioral analysis 602, transaction trend time information 606, transaction product pattern information 608, and/or transaction location 610 have been changed to be enclosed with broken lines. In addition, behavioral node 3 shown at 618, behavioral data node 4 shown at 620, behavioral data node 7 shown at 626, and behavioral data node 8 shown at 628, as well as executable decision prompt 4 shown at 634 have also been indicated in broken lines.

The broken lines indicate that, in a specific scenario, information gains derived from selected inputs, selected data nodes, and one or more selected executable decision prompts may be invoked. In the exemplary set of circumstances set forth above, the entity client travels to the Florida Superstore every 10 days to transaction a specific children's food product, then the embodiments set forth herein may interpret that behavior and message the customer—“Hi John! Hope you are here to buy ABC Cerelac for your child. With your permission, can we make a pre-transaction payment of $121 to the Florida Superstore right now?”

Upon receiving confirmation from the customer, the system may pre-wire the Florida Superstore payment system with the customer's payment digital wallet information. Once the customer has received an electronic transaction receipt on the customer's mobile device, the customer can enter the store, retrieve the transacted object and show an electronic receipt on his or her mobile device at store exit; thereby obviating the need for check-out. The foregoing exemplary circumstances preferably implicate only the elements that are indicated in broken lines—i.e., inputs environmental and behavioral analysis 602, transaction trend time information 606, transaction product pattern information 608, transaction location 610, behavioral node 3 shown at 618, behavioral data node 4 shown at 620, behavioral data node 7 shown at 626, and behavioral data node 8 shown at 628, and executable decision prompt 4 shown at 634. Thus, it has been shown that not all of the components are implicated in every system action. Nevertheless, selected components are implicated in certain system actions.

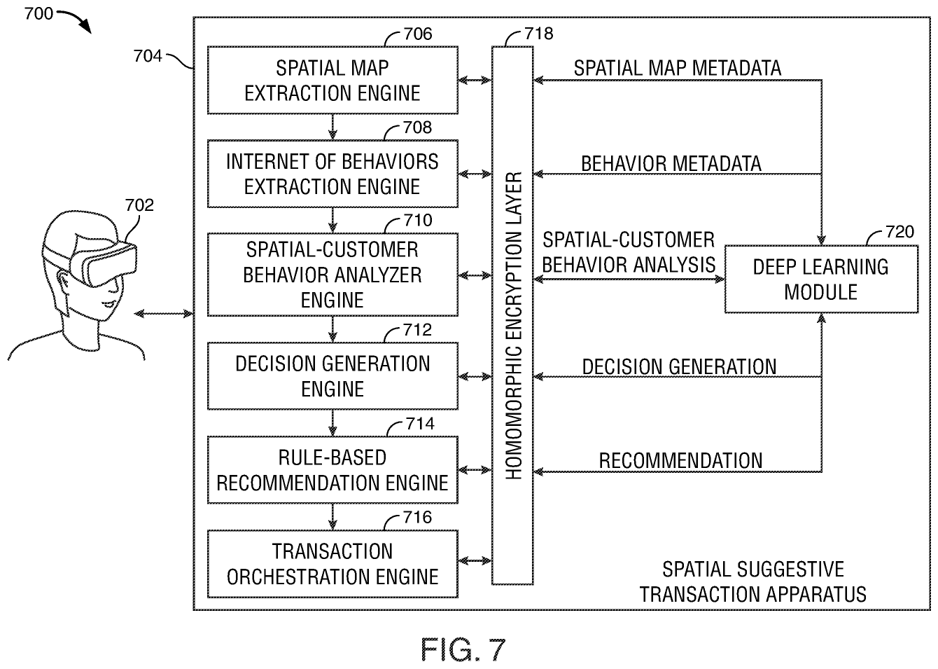

FIG. 7 shows a schematic diagram of a spatial suggestive transaction system 700. System 700 includes user wearing spatial computing device 702. System 700 includes spatial suggestive transaction apparatus 704.

Apparatus 704 preferably includes a communication architecture and apparatus for directing encrypted traffic. Specifically, apparatus 700 includes a spatial map engine 706 IoB extraction engine 708, spatial-customer behavior analyzer engine 710, decision generation engine 712, rules-based recommendation engine 714, and transaction orchestration engine 716.

In addition to engines 706, 708, 710, 712, 714 and 716, apparatus 704 also preferably includes a deep learning module (alternatively, deep learning engine) 720. Preferably, spatial map engine 706, internet of behaviors (“IoB”) extraction engine 708, spatial-customer behavior analyzer engine 710, decision generation engine 712, rules-based recommendation engine 714, and transaction orchestration engine 716 communicate bi-directionally with deep learning module 720 through homomorphic encryption layer 718.

Homomorphic encryption layer 718 may include partial homomorphic encryption. Homomorphic encryption layer 718 may include a full homomorphic encryption. Homomorphic encryption carried out by layer 718 may include conversion of data included in a transaction data packet into ciphertext that may be analyzed and worked with as if the data were in its original form. Homomorphic encryption may allow for data to be processed, analyzed and transmitted without having to decrypt the data. The methods may include homomorphically encrypting data for use by deep learning module 720. The methods may include homomorphically encrypting data relating to data for transmission by learning module 720.

For example, data relating to pending possible suggestions for recommendations may include personal/confidential information related to the sender or the receiver of the transaction. Personal/confidential information may include information such as sender or receiver financial information, sender or receiver authentication information, and any other suitable sender or receiver information that should not be made public. As such, data relating to the pending transaction may be homomorphically encrypted to protect and secure any included personal/confidential information related to the sender or the receiver of the transaction. On the other hand, data relating to sender-node identification and receiver-node identification may not be homomorphically encrypted. Data relating to sender-node identification and receiver-node identification may not be personal/confidential and may therefore not require homomorphic encryption.

Thus, a SPATIAL COMPUTING DEVICE FOR USE WITH TELEMETRY-BASED USER BEHAVIOR ANALYSIS FOR LEVERAGING SUGGESTIVE ACTION MECHANISMS is provided. Persons skilled in the art will appreciate that the present invention can be practiced by other than the described embodiments, which are presented for purposes of illustration rather than of limitation. The present invention is limited only by the claims that follow.

What is claimed is:

1. A method for utilizing a spatial computing device with telemetry-based user-behavior analysis for leveraging suggestive action mechanisms, said method comprising:
retrieving, using the spatial computing device, a 360° view of a transaction area;
performing environmental analysis of the transaction area;
invoking customer physical behavior analysis in the transaction area;
reviewing user sentiment of legacy transactions in the transaction area;
monitoring a user transaction trend in the transaction area;
monitoring a user transaction product pattern in the transaction area;
identifying a geo-location of the transaction area;
based on the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area, forming a pre-transaction integration of the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area; and
based on the pre-transaction integration, generating an enabling prompt at the spatial computing device, said enabling prompt configured to receive a transaction execution command.

2. The method of claim 1, wherein the retrieving, using the spatial computing device, of the 360° view of the transaction area comprises assigning one or more anchors to sub-regions within the transaction area.

3. The method of claim 1, wherein the retrieving, using the spatial computing device, of the 360° view of the transaction area comprises assigning one or more anchors to each of a plurality of individual products within the transaction area.

4. The method of claim 1, wherein the retrieving, using the spatial computing device, of the 360° view of the transaction area comprises assigning one or more spatial anchors to each of a plurality of groups of products within the transaction area.

5. The method of claim 1 further comprising implementing the telemetry-based user-behavior analysis using an iterative adjunction technique.

6. The method of claim 5, wherein the iterative adjunction technique analyzes each of the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area in order to provide a root node in a graph.

7. The method of claim 6, wherein the iterative adjunction technique further comprises iterating through one or more information gains.

8. The method of claim 7, wherein each one or more of the information gains are used to generate an additional node on the graph.

9. The method of claim 8 wherein each of the root node and the additional node(s) on the graph is leveraged to provide the pre-transaction integration for a formation of an enabling prompt.

10. The method of claim 7, wherein the iterative adjunction technique further comprises iterating through one or more information gains and wherein each of the one or more information gains are associated with an information delta derived from a change to one of the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area.

11. A system for telemetry-based user-behavior analysis, said system for leveraging suggestive action mechanisms, said system comprising:
a spatial computing device for retrieving and monitoring a 360° view of a transaction area, the spatial computing device further operable to:
perform environmental analysis of the transaction area;
invoke customer physical behavior analysis in the transaction area;
review user sentiment of legacy transactions in the transaction area;
monitor a user transaction trend in the transaction area;
monitor a user transaction product pattern in the transaction area;
identify a geo-location of the transaction area;
form a pre-transaction integration of the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area; and
a central server, wherein, based on the pre-transaction integration, the spatial computing device is further operable to transmit to the central server the pre-transaction integration which, in turn and following additional verification and analysis performed at the central server, transmits an enabling prompt to the spatial computing device, said enabling prompt configured to receive a transaction execution command.

12. The system of claim 11, wherein the spatial computing device is further operable to assign one or more anchors to sub-regions within the transaction area.

13. The system of claim 11, wherein the spatial computing device is further operable to assign one or more anchors to each of a plurality of individual products within the transaction area.

14. The system of claim 11, wherein the spatial computing device is further operable to assign one or more spatial anchors to each of a plurality of groups of products within the transaction area.

15. The system of claim 11, wherein the spatial computing device is further configured to implement the telemetry-based user-behavior analysis using an iterative adjunction technique.

16. The system of claim 15, wherein the iterative adjunction technique analyzes each of the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area in order to provide a root node in a graph.

17. The system of claim 16, wherein the iterative adjunction technique further comprises iterating through one or more information gains, said information gains derived from analysis of one or more of the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area.

18. The system of claim 17, wherein each one or more of the information gains are used to generate a node, additional to the root node, in the graph.

19. The system of claim 18, wherein each of the root node and the additional node(s) on the graph is leveraged to provide the pre-transaction integration for a formation of the enabling prompt.

20. The system of claim 16, wherein the iterative adjunction technique further comprises iterating through the one or more information gains and wherein each of the one or more information gains is associated with an information delta derived from a change to one of the 360° view of the transaction area, the environmental analysis of the transaction area, the customer physical behavior analysis in the transaction area, the user sentiment of legacy transactions in the transaction area, the user transaction trend in the transaction area, the user transaction product pattern in the transaction area, and the geo-location of the transaction area.

21. A method for utilizing a spatial computing device with telemetry-based user-behavior analysis for leveraging suggestive action mechanisms, said method comprising:
retrieving, using the spatial computing device, a 360° view of a transaction area;
based on the 360° view of the transaction area, forming a pre-transaction suggestion with respect to the transaction area; and
based on the pre-transaction integration, transmitting an enabling prompt to the spatial computing device, said enabling prompt configured to receive a transaction execution command.
